(19) United States
(12) Patent Application Publication
(10) Pub. No.: US 2006/0187213 A1
(43) Pub. Date: Aug. 24, 2006

(54) Electroluminescence display with touch panel

(75) Inventor: Chih-Hung Su, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/195,488

(22) Filed: Aug. 2, 2005

(30) Foreign Application Priority Data
Feb. 21, 2005 (TW) 94105045

(51) Int. Cl. G09G 5/00

(52) U.S. Cl. 345/173

(57) ABSTRACT

An electroluminescence display with a touch panel comprises a first substrate, an organic light emitting element disposed on the first substrate, a passivation layer disposed on the organic light emitting element, a resistive touch panel element disposed on the passivation layer, and a second substrate disposed on the resistive touch panel element. The resistive touch panel element comprises an analog touch panel element or a digital touch panel element.

### BACKGROUND

The invention relates to an organic light emitting diode (OLED) display, and more particularly, to an organic light emitting diode (OLED) display with a touch panel.

Among flat panel displays, organic light emitting diode (OLED) displays exhibit characteristics of self-emission, high brightness, wide viewing angle, high response, simple fabrication process, low power consumption, and good outdoor reliability, and are therefore widely applied in portable computers, notebooks, mobile phones, and personal digital assistances (PDAs).

Touch panel displays are conventionally applied in laptops, notebooks, or personal computers, particularly in portable electronic devices such as personal digital assistants. Conventionally, touch panel may be a position sensitive display detecting the location of a stylus directly contacting the panel.

For example, conventional resistive touch panel displays comprise a resistive touch panel detecting position of a stylus contact thereon.

U.S. PG. Publication No. 2002/0167270 and 2002/0171610, the entirety of which are hereby incorporated by reference, disclose a touch panel OLED display. FIG. 1 is a schematic view of a conventional touch panel integrating an OLED display. A touch panel 14 and an OLED display 52 are separately formed on two substrates 50 and 12. Subsequently, the touch panel 14 and the OLED display 52 are packaged in a frame 68. The two substrates 50 and 12 are separated by a gap 72. The touch panel 14 and the OLED display 52 are separately connected to an external circuit by electrode extensions 16 and 67. A typical OLED display 52 comprises an anode 54, a hole transport layer 56, an organic light emitting layer 58, an electron transport layer 60, and a cathode 62. A driving circuit 64 connects the anode 54 and cathode 62. The OLED display 52 is a bottom emission OLED. The organic light emitting layer 58 comprises R, G, B pixel layers.

Thickness of a conventional touch panel integrating an OLED display is compromised by the control panel 14, OLED display 52, and substrates 50 and 12 and the gap 72 therebetween. The touch panel 14 and OLED display 52, separately formed, increase high production costs.

### SUMMARY

Accordingly, the invention provides a touch panel integrating an organic light emitting diode (OLED) display at reduced total thickness.

The invention provides an electroluminescence display with a touch panel, comprising a first substrate, an electroluminescent element disposed on the first substrate, a passivation layer disposed on the electroluminescent element, a resistive touch panel element disposed on the passivation layer, and a second substrate disposed on the resistive touch panel element.

Note that the resistive touch panel element is an analog touch panel element, comprising a first electrode directly disposed on the passivation layer, a second electrode disposed on the second substrate opposing the OLED element, and a plurality of spacers disposed between the first electrode and the second electrode.

Alternatively, the resistive touch panel element can be a digital touch panel element, comprising a plurality of parallel first electrode lines directly disposed on the passivation layer, a plurality of parallel second electrode lines disposed on the second substrate opposing the OLED element, and a plurality of spacers disposed between the first electrode lines and the second electrode lines.

### DESCRIPTION OF THE DRAWINGS

The invention can be more fully understood by reading the subsequent detailed description in conjunction with the examples and references made to the accompanying drawings, wherein

FIG. 1 is a schematic view of a conventional touch panel integrating an OLED display;

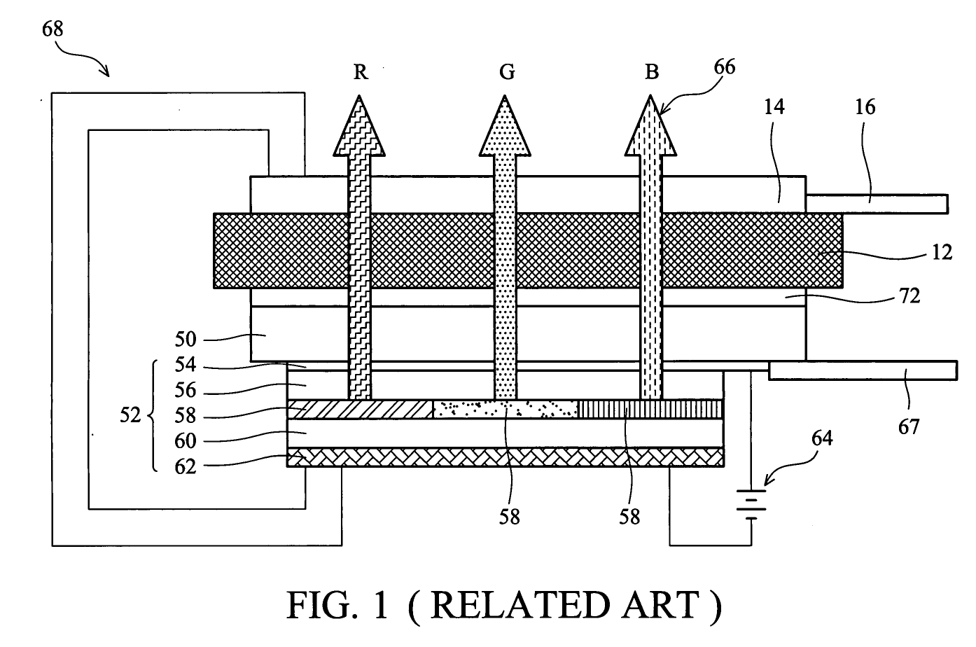

FIG. 2 is a cross section of an embodiment of a touch panel integrating an organic light emitting diode (OLED) device;

FIG. 3a is a cross section of an embodiment of a touch panel integrating an organic light emitting diode (OLED) device; and

FIG. 3b is a schematic view of the touch panel integrating an organic light emitting diode (OLED) device in FIG. 3a.

### DETAILED DESCRIPTION

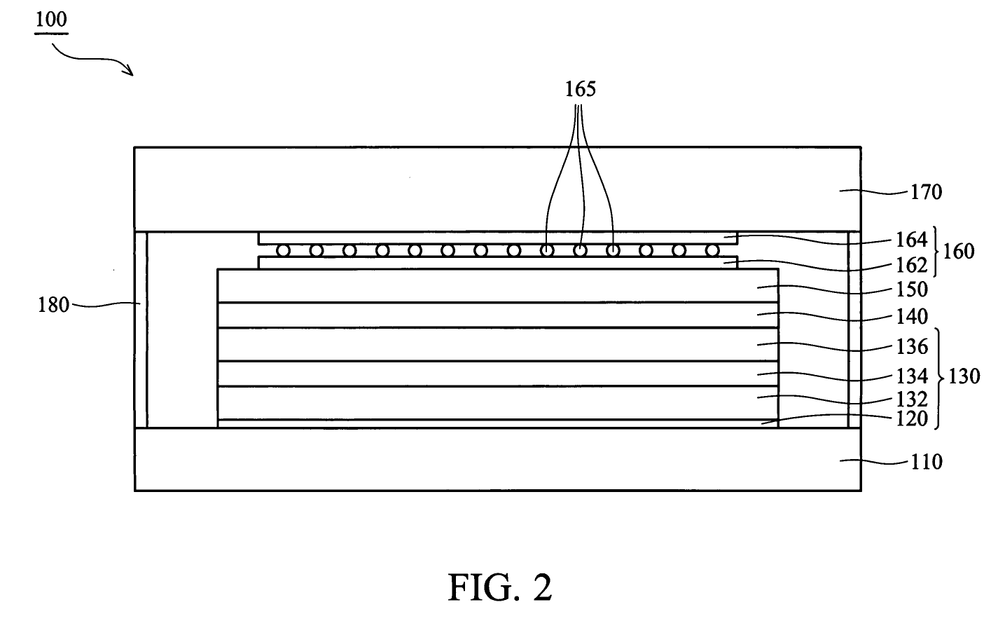

FIG. 2 is a cross section of an embodiment of a touch panel integrating an organic light emitting diode (OLED) device, in which a touch panel organic light emitting diode (OLED) display 100 comprises a first substrate 110, an organic light emitting element 130 disposed on the first substrate 110, a passivation layer 150 disposed on the organic light emitting element 130, a resistive touch panel element 160 disposed on the passivation layer 150, and a second substrate 170 disposed on the resistive touch panel element 150. The resistive touch panel element 160 is electrically connected to the organic light emitting element 130 by a circuit (not shown).

The first substrate is a transparent substrate, such as a glass substrate or an active matrix substrate with thin film transistor (TFT) array thereon.

The organic light emitting element 130 preferably comprises a top emission OLED element and emits light toward the resistive touch panel element 160 or an output direction. The organic light emitting element 130 comprises a first electrode 120 such as a transparent electrode disposed on the first substrate 110 acting as an anode of the organic light emitting element 130. The first electrode 120 comprises indium tin oxide (ITO), indium zinc oxide (IZO), aluminum zinc oxide (AZO), or zinc oxide deposited by sputtering, electron beam (e-beam) evaporation, thermal evaporation, chemical vapor deposition (CVD), or thermal spray decomposition.

An organic light emitting diode structure comprises a hole transport layer 132 disposed on the first electrode 120. An organic light emitting layer 134 is disposed on the electron transport layer 132. An electron transport layer 136 is disposed on the organic light emitting layer 134. The hole transport layer 132, organic light emitting layer 134, and electron transport layer 136 make up the organic light emitting diode. The organic light emitting layer 134 can be oligomer or polymer, having single or multiple layers. The oligomer light emitting layer can be formed by thermal evaporation. Alternatively, the polymer light emitting layer can be formed by spin-on deposition, ink jet printing, or screen printing.

A second electrode 140 is disposed on electron transport layer 136 acting as a cathode of the organic light emitting element 130. The second electrode 140 may comprise calcium (Ca), silver (Ag), magnesium (Mg), aluminum (Al), lithium (Li), or other low work function materials, or combination thereof, formed by vacuum thermal evaporation or sputtering.

A passivation layer 150 is disposed on the second electrode 140. The passivation layer 150 may comprise an insulating layer such as silicon nitride, silicon oxide, silicon oxynitride, or silicon carbide. Alternatively, the passivation layer 150 may comprise metal such as silver, aluminum, platinum, or alloys thereof.

A resistive touch panel element 160 is disposed on the passivation layer 150. According to the invention, the resistive touch panel element 160 is an analog touch panel element, comprising a third electrode 162 directly disposed on the passivation layer 150, a fourth electrode 164 disposed on the second substrate 170 opposing the OLED element 130, and a plurality of spacers 165 disposed between the third electrode 162 and the fourth electrode 164.

A sealer 180 is formed at the peripheral region of the OLED display. The sealer 180 seals the first substrate 110 and the second substrate 170. Alternatively, the first substrate 110 and the second substrate 170 can also be sealed by a metal frame.

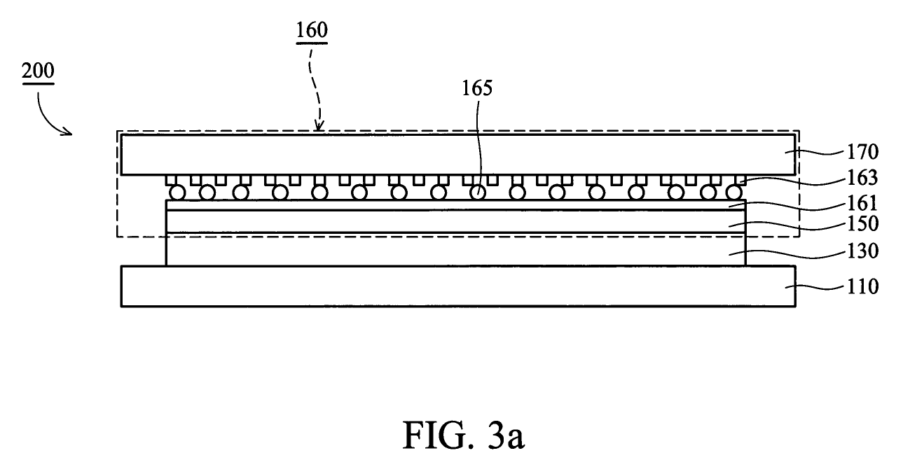

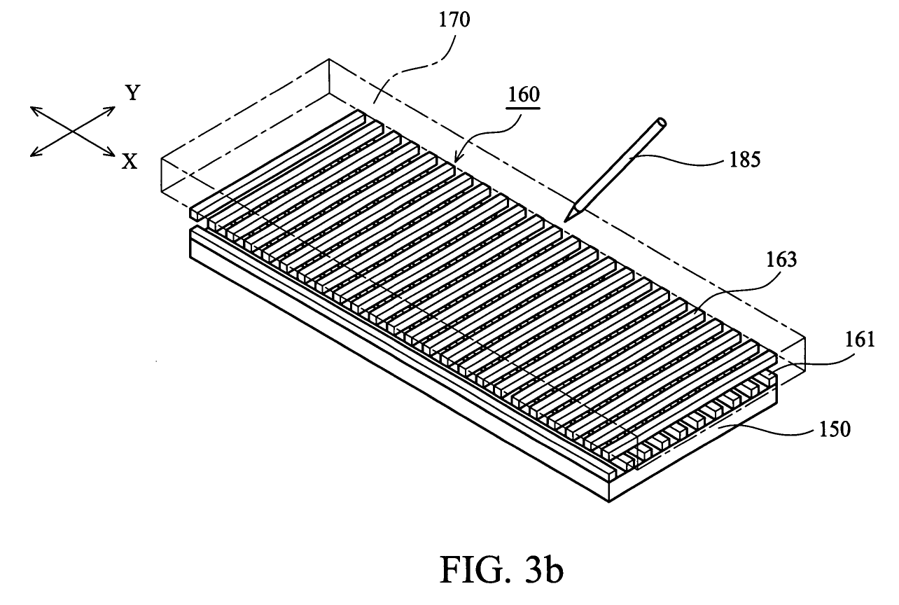

FIG. 3a is a cross section of an embodiment of the touch panel 160 integrating an organic light emitting diode (OLED) device 200. The touch panel 160 is a digital touch panel element, comprising a plurality of parallel first electrode lines 161 along transverse axis X directly disposed on the passivation layer 150. A plurality of parallel second electrode lines 163 along longitudinal axis Y crossing the first electrodes 161 disposed on the second substrate 170 opposing the OLED element 130. A plurality of spacers 165 are disposed between the first electrode lines 161 and the second electrode lines 163.

FIG. 3b is a schematic view of the touch panel 160 integrating an organic light emitting diode (OLED) device 200 in FIG. 3a. When a stylus 185 directly or substantially contacts the resistive digital touch panel element 160, the intersecting position of the first line lines 161 (X direction) and the second electrode lines 163 (Y direction) corresponds to the site (X, Y) of the OLED display 200.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An electroluminescence display with a touch panel, comprising:
a first substrate;
an electroluminescent element disposed on the first substrate;
a passivation layer disposed on the electroluminescent element;
a resistive touch panel element disposed on the passivation layer; and
a second substrate disposed on the resistive touch panel element.

2. The display as claimed in claim 1, wherein the electroluminescent element comprises a luminant surface facing the resistive touch panel element.

3. The display as claimed in claim 1, wherein the electroluminescent element comprises:
a first electrode disposed on the first substrate;
an organic light emitting layer disposed on the first electrode; and
a second electrode disposed on the organic light emitting layer.

4. The display as claimed in claim 1, wherein the passivation layer comprises an insulating layer.

5. The display as claimed in claim 4, wherein the passivation layer comprises silicon nitride, silicon oxide, silicon oxynitride, or silicon carbide.

6. The display as claimed in claim 1, wherein the passivation layer comprises a metal layer.

7. The display as claimed in claim 6, wherein the passivation layer comprises silver, aluminum, platinum, or an alloy thereof.

8. The display as claimed in claim 1, wherein the resistive touch panel element comprises:
a first electrode directly disposed on the passivation layer;
a second electrode disposed on the second substrate opposing the electroluminescent element; and
a plurality of spacers disposed between the first electrode and the second electrode.

9. The display as claimed in claim 1, wherein the resistive touch panel element comprises:
a plurality of first electrode lines substantially parallel to each other and directly disposed on the passivation layer;
a plurality of second electrode lines substantially parallel to each other and disposed on the second substrate opposing the electroluminescent element; and
a plurality of spacers disposed between the first electrode lines and the second electrode lines.
